(19) United States
(12) Patent Application Publication
(10) Pub. No.: US 2003/0022977 A1
(43) Pub. Date: Jan. 30, 2003

(54) Soft gel compatibilized polymer compound having low hysteresis

(76) Inventor: James E. Hall, Mogadore, OH (US)

Correspondence Address: Chief Intellectual Property Counsel, Bridgestone/Firestone, Inc., 1200 Firestone Parkway, Akron, OH, 44317-0001, US

(21) Appl. No.: 09/828,113

(22) Filed: Apr. 6, 2001

(51) Int. Cl. C08K 5/01

(52) U.S. Cl. 524/481

(57) ABSTRACT

A soft polymer gel composition includes a copolymer with at least two different blocks selected from vinyl-substituted aromatic hydrocarbons and conjugated dienes and a polymer comprising a polymeric ether resin. The polymer gel is extended by a synthetic oil. It can be prepared by simple mixing of the three components.

### BACKGROUND OF THE INVENTION

The invention relates to low hysteresis gels with superior high-temperature compression set, mechanical strength and moldability.

Two or more polymers may be blended together to form a wide variety of random or structured morphologies to obtain desirable characteristics. However, it may be difficult or even impossible in practice to achieve many potential combinations through simple blending. Frequently, the two polymers are thermodynamically immiscible, which precludes generating a truly homogeneous product. While it is often desirable to have a two-phase system, the interface between the two phases may result in problems. For example, high interfacial tension and poor adhesion may exist between the two phases. Interfacial tension contributes, along with high viscosities, to the inherent difficulty of imparting the desired degree of dispersion to random mixtures and to their subsequent lack of stability, giving rise to gross separation or stratification during processing or use. Poor adhesion can lead to weak and brittle mechanical behavior and may render some highly structured morphologies impossible.

To address some of these problems, mineral oil has been used to extend polymer compositions and increase flexibility of the polymers. For example, triblock SEPS/PPO/Mineral Oil, has shown compression set values at 100° C. of less than 50%, and a hysteresis value at greater than 10° C. of less than 0.100. However, polymer compositions extended with mineral oils may nonetheless show poor hysteresis values at temperatures lower than about 20° C.

Copolymer compositions that exhibit improved properties such as tensile strength, maximum elongation, tear strength, high temperature compression set, and low hysteresis values remain desirable.

### SUMMARY OF THE INVENTION

According to an exemplary embodiment, the present invention is directed to a blend of multi block copolymers, polymeric ether resin, and a synthetic oil of at least one polyalkylene. Preferably, the multi block copolymer includes at least two different blocks selected from a vinyl-substituted aromatic hydrocarbon and a conjugated diene. Preferably, the polymeric ether resin is a polyphenylene oxide.

In another aspect, a process for forming a polymer composition is provided. A polymer having at least 2 different blocks selected from a vinyl-substituted aromatic hydrocarbon and a conjugated diene is mixed with at least one polymeric ether resin and a synthetic oil including at least one polyalkylene.

### DETAILED DESCRIPTION OF ILLUSTRATIVE EMBODIMENTS

A preferred class of polymers suited to this invention are triblock copolymers containing at least two blocks A of a vinyl-substituted aromatic hydrocarbon and at least one block B of a conjugated diene, although diblock copolymers including at least one block A of a vinyl-substituted aromatic hydrocarbon and at least one block B of a conjugated diene are also contemplated. The triblock copolymer can have the polymer structure represented by the formulae (AB)ₙA, (BAB)ₙA, (BAB)ₙAB, (AB)ₘX, etc., wherein n is an integer of 1 or more, m is an integer of 2 or more, and X represents a coupling or polyfunctional initiator residue having two or more functional groups. The triblock copolymer may be any of straight chain, branched involving partial coupling with a coupling agent, radial, the star-shaped types and combinations thereof

The triblock polymer usually contains about 5 to 60 wt. % of a vinyl-substituted aromatic hydrocarbon and about 40 to 95 wt. % of a conjugated diene. Each polymer block may take any of random, tapered, partial block arrangements, and combinations thereof, and may have the same or different arrangements.

Useful vinyl-substituted aromatic hydrocarbon contributed monomer units of the triblock copolymer include one or more of styrene, α-methylstyrene, p-methyl-styrene, 1-vinyl naphthalene, 2-vinyl naphthalene, 1-a-methyl vinyl naphthalene, 2-a-methyl vinyl naphthalene, as well as alkyl, cycloalkyl, aryl, alkaryl, and aralkyl derivatives thereof, in which the total number of carbon atoms in the combined hydrocarbon is generally not greater than 18, as well as any di- or tri-vinyl substituted aromatic hydrocarbons. Preferred vinyl-substituted aromatic hydrocarbons include styrene, p-methylstyrene, and/or α-methylstyrene.

Representative conjugated diene contributed monomer units of the triblock copolymer are chosen from one or more of 1,3-butadiene, isoprene, 2,3-dimethyl-1,3-butadiene, 1,3-pentadiene, and mixtures thereof. Preferred conjugated dienes include 1,3-butadiene, isoprene, and mixtures thereof.

The triblock copolymer is preferably hydrogenated to remove double bonds remaining in the polymer backbone after polymerization. The hydrogenation step is beneficial for products which will be used at high temperatures, such as greater than 45° C., particularly between about 50° and 125° C. Hydrogenation can be performed by a variety of methods known in the art.

Preferred triblock copolymers include SEPS and SEBS. SEPS is a styrene-ethylene-propylene-styrene polymer, wherein the ethylene-propylene portion of the polymer is derived from hydrogenated isoprene units. SEBS is a styrene-ethylene-butene-styrene polymer, wherein the ethylene-butene portion of the polymer is derived from hydrogenated conjugated butadiene units. Other triblocks containing hydrogenated conjugated diene segments are also contemplated as useful in the present invention.

The triblock copolymer used in the present invention preferably has a number average molecular weight (Mₙ) in a range from about 100,000 to 1,000,000, preferably from 125,000 to 800,000, more preferably 150,000 to 500,000, and the molecular weight distribution ratio (M_{w}/Mₙ) is 10 or less. The triblock copolymers can be formed by any of a variety of known methods including, for example, by synthesizing a vinyl-substituted aromatic hydrocarbon/conjugated diene block copolymer in an inert solvent using an organolithium anionic initiator.

The triblock copolymer, preferably hydrogenated, and polyalkylene synthetic oil are mixed with one or more polymeric ether resin. A preferred resin is polyphenylene ether resin. These three components can be mixed in any conventional mixing apparatus including an open-type mixing roll, closed-type Banbury mixer, closed-type Brabender mixer, extruding machine, kneader, continuous mixer, etc. The closed-type Brabender mixer is preferable, and mixing in an inactive gas environment, such as N₂ or Ar, also is preferable.

Polyphenylene ether resins improve the high-temperature properties, for example, compression set of polymer gel compositions. This resin may be a homo- and/or co-polymer including a binding unit represented by the general formula:

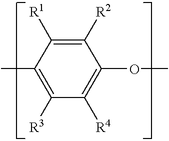

wherein R¹, R², R³, and R⁴, which may be the same or different, represent substituents selected from one or more of hydrogen, halogen, hydrocarbon groups, and substituted hydrocarbon groups. The well-known polyphenylene ether (PPO) resins may be used, examples of which include poly(2,6-dimethyl-1,4-phenylene ether), poly(2-methyl-6-ethyl-1,4-phenylene ether), poly(2,6-diphenyl-1,4-phenylene ether), poly(2-methyl-6-phenyl-1,4-phenylene ether), poly(2,6-dichloro-1,4-phenylene ether), and the like. Furthermore, copolymers of 2,6-dimethylphenol with other phenols may also be used. Poly(2,6-dimethyl-1,4-phenylene ether) is preferred.

The PPO resin preferably has a M_{w} between about 20,000 and 100,000, more preferably between about 25,000 and 90,000.

The amount of PPO, blended with the copolymer, is preferably in a range of from more than 0 to about 150 parts by weight (pbw) based on 100 parts by weight of the triblock copolymer. When the amount exceeds about 150 pbw, the hardness of the resultant polymer blend may be too high, so that the blend loses flexibility and becomes resinous.

Optionally, the PPO resin employed may be a blend of PPO and vinyl-substituted aromatic hydrocarbons, such as polystyrene. Preferred resins include about 50-85% by weight PPO and about 15-50% by weight vinyl-substituted aromatic hydrocarbon polymer, most preferably about 65-75% PPO and 25-35% vinyl-substituted aromatic hydrocarbon polymer.

The third component of the blend, a polyalkylene synthetic oil, is used to extend the polymer blend. The synthetic oil used can be any polyalkylene, preferably amorphous, including polypropylene, polybutene, polypentene, polyhexene, polyheptene, polyoctene, polynonene, polydecene, polyundecene, polydodecene, other polyalkenes with up to about 16 carbon atoms in the monomer unit, and mixtures thereof A particularly preferred synthetic oil will include from about 3 to 12 carbon atoms. The synthetic oil preferably has an Mₙ in the range from about 500 to 3000, more preferably about 700 to 1500. Preferred synthetic oils are poly-1-decene and poly-1-dodecene.

Polymers mixed with a polyalkylene synthetic oil have demonstrated hysteresis values which are reduced by 35-40% at 20° C. over polymers mixed with other mineral oils. When temperatures are as low as −10° C., the hysteresis values are reduced by up to about 70%. The high temperature compression set of the polymers mixed with polyalkylene synthetic oil is generally maintained relative to that of the polymers mixed with other mineral oils.

Exemplary synthetic oils for use in the invention may be obtained from Chevron Oronite Company, Houston, Tex., such as the poly-1-decene and poly-1-dodecene synthetic oils known as Synfluid™ PAO. Preferred synthetic oils include the PAO 6 and PAO 8 grades, which are poly-1-decene oils, and the PAO 7 and PAO 9 grades, which are poly-1-dodecene oils.

Inclusion of other additives well known in the art to the blends of the present invention can be desirable. Stabilizers, antioxidants, conventional fillers, reinforcing agents/resins, pigments, fragrances, and the like are examples thereof. Specifically useful antioxidants and stabilizers include 2-(2′-hydroxy-5′-methylphenyl) benzotriazole, nickel di-butyl-di-thiocarbamate, zinc di-butyl-di-thiocarbamate, tris(nonyl-phenyl) phosphite, and 2,6-di-t-butyl-4-methylphenol. Exemplary conventional fillers and pigments include silica, carbon black, titanium dioxide, and iron oxide. These compounding ingredients are incorporated in suitable amounts depending upon the contemplated use of the product, preferably in the range of about 1-350 parts of additive per 100 parts polymer.

A reinforcing agent/resin may be defined as a material added to a resinous matrix to improve the strength of the polymer(s). Reinforcing materials are often inorganic or organic products of high molecular weight, and include glass fibers, asbestos, boron fibers, carbon and graphite fibers, whiskers, quartz and silica fibers, ceramic fibers, metal fibers, natural organic fibers, and synthetic organic fibers. Other elastomers and resins are also useful to enhance properties like damping, adhesion, and processability. Examples of other elastomers and resins include Reostomer™ (adhesive-like products Riken-Vinyl, Inc., Tokyo, Japan), and similar materials, hydrogenated polystyrene-(medium or high 3,4) polyisoprene-polystyrene block copolymers such as Hybler™ hydrogenated copolymers (Kurary Co., Ltd., Osaka, Japan), and polynorbornenes such as Norsorex™ rubber (Nippon Zeon Corp., Tokyo, Japan).

The blended polymer composition, or soft gel, can be molded with equipment conventionally used for molding thermoplastics and is suitable for extrusion molding, calendar molding, and particularly injection molding. These compositions can also be solution mixed in appropriate solvents such as, e.g., cyclohexane or toluene.

The blended polymer composition may be molded in appropriate press ovens to form products in the form of extruded pellets and cut dice, preferably as small as possible since smaller pellets provide short heating times and better flow when utilized in flow molding. Ground pellets may also be utilized.

The blended polymer composition can be used in high temperature applications or as a blending component in any other compositions typically used for their elastomeric properties.

The blended polymer composition is favorably used in the manufacturing of any product in which the following properties are advantageous: a high degree of softness, heat resistance, decent mechanical properties, and elasticity. The compositions of the present invention can be used in many industry fields, in particular, in the fabrication of automotive parts, household electrical appliances, industrial machinery, precision instruments, transport machinery, constructions, engineering, and medical instruments.

Representative examples of the uses of the instant soft gels are seals, vibration restraining materials, and cushion gels. These uses involve connecting materials such as sealing materials, packing, gaskets, and grommets; supporting materials such as mounts, holders, and insulators; and cushion materials; such as stoppers, cushions, and bumpers. These materials are also used in equipment producing vibration or noise and household electrical appliances, such as in air conditioners, laundry machines, refrigerators, electric fans, vacuums, dryers, printers, and ventilator fans. Further, these materials are also suitable for impact absorbing materials in audio equipment and electronic or electrical equipment, sporting goods, and shoes. Further, as super low hardness rubbers, these materials are suitable for use in appliances and as, damping rubbers. Since the present compositions can be used to control the release of internal low molecular weight materials out from the compositions, they are useful as a release support to emit materials such as fragrance materials, medical materials, and other functional materials. The compositions of the present invention also possess utility in applications of use in liquid crystals, adhesive materials, and coating materials.

The present invention will be described in more detail with reference to non-limiting examples. The following examples and tables are presented for purposes of illustration only and are not to be construed in a limiting sense.

### EXAMPLES

The following products were used in Examples 1-25:

SEPS (Kuraray Co., Ltd.);

PPO is poly(2,6-dimethyl-1,4-phenylene oxide);

mineral oil (Idemitsu Kosan Co., Ltd., Tokyo, Japan;

PAO-6, -7, -8, and -9 as described above; and

PPO/PS are polymeric ether resins (GE Polymerland, Huntersville, N.C.)

### Examples 1-2

A SEPS triblock copolymer was mixed with a polyphenylene oxide resin and oil by dissolving the materials in toluene. The blended polymer compositions were recovered by drum-drying the solutions.

### Examples 3-5

A SEPS triblock copolymer was mixed with a polyphenylene oxide resin and oil in a Brabender mixer at 280° C. In example 5, the PPO was a mixture of PPO (70%) and polystyrene (30%).

Physical characteristics of the products from Examples 1-5 are provided in 10 Table 1.

TABLE 1

| | 1 | 2 | 3 | 4 | 5 |
|---|---|---|---|---|---|
| Oil | Mineral oil | PAO-8 | Mineral Oil | PAO-8 | Mineral Oil |
| SEPS/ | 31/9/60 | 31/9/60 | 31/9/60 | 31/9/60 | 31/12/57 |
| PPO/OIL | | | | | |
| (pbw) | | | | | |
| Shore A | 15 | 17 | 10 | 8 | 14 |
| Asker C | 46 | 46 | 35 | 31 | 38 |
| 100° C. | 57.4% | 46.0% | 23.0% | 25.9% | 27.5% |
| C.S. | | | | | |
| tan δ @ | 0.089 | 0.077 | 0.146 | 0.061 | 0.147 |
| 0° C. | | | | | |
| tan δ @ | 0.064 | 0.066 | 0.067 | 0.045 | 0.071 |
| 20° C. | | | | | |
| tan δ @ | 0.64 | 0.68 | 0.054 | 0.047 | 0.060 |
| 40° C. | | | | | |
| tan δ @ | 0.68 | 0.70 | 0.053 | 0.052 | 0.061 |
| 60° C. | | | | | |

As can be seen from Table 1, the hysteresis values of solution mixed compounds containing synthetic oils approximate those containing mineral oil. When the compounds were mixed in a Brabender mixer, as seen in Examples 3-5, the hysteresis values showed improvement.

### Examples 6-15

A SEPS triblock copolymer was mixed with oil and PPO/PS resins in a Brabender mixer at 250° C. The physical characteristics of examples 6-15 can be seen in Table 2.

TABLE 2

| | 6 | 7 | 8 | 9 | 10 | 11 | 12 | 13 | 14 | 15 |
|---|---|---|---|---|---|---|---|---|---|---|
| SEPS | 40 | 30 | 25 | 20 | 30 | 30 | 40 | 35 | 25 | 20 |
| (pbw) | | | | | | | | | | |
| PPO/PS | 0 | 10 | 15 | 20 | 15 | 20 | 0 | 10 | 15 | 20 |
| (pbw) | | | | | | | | | | |
| Mineral | 60 | 60 | 60 | 60 | 55 | 50 | 60 | 60 | 60 | 60 |
| oil (pbw) | | | | | | | | | | |
| Asker C | 33.5 | 33 | 31 | 28 | 41 | 57.5 | 32 | 31.5 | 27 | 27 |
| Shore A | 12 | 10 | 9 | 7 | 16 | 33 | 9 | 8 | 8 | 9 |
| 100° C. | 40.0 | 20.0 | 17.8 | 18 | 11.7 | 30.6 | 41.2 | 20.7 | 24.0 | 24.7 |
| C.S. (%) | | | | | | | | | | |
| tan δ @ | 0.213 | 0.247 | 0.257 | 0.298 | 0.233 | 0.212 | 0.063 | 0.073 | 0.08 | 0.089 |
| −10° C. | | | | | | | | | | |
| tan δ @ | 0.127 | 0.145 | 0.158 | 0.181 | 0.150 | 0.142 | 0.045 | 0.054 | 0.06 | 0.068 |
| 0° C. | | | | | | | | | | |
| tan δ @ | 0.074 | 0.088 | 0.101 | 0.113 | 0.097 | 0.101 | 0.035 | 0.043 | 0.051 | 0.062 |
| 10° C. | | | | | | | | | | |
| tan δ @ | 0.053 | 0.063 | 0.071 | 0.084 | 0.071 | 0.082 | 0.034 | 0.039 | 0.046 | 0.055 |
| 20° C. | | | | | | | | | | |
| tan δ @ | 0.043 | 0.055 | 0.061 | 0.071 | 0.062 | 0.076 | 0.032 | 0.039 | 0.048 | 0.059 |
| 30° C. | | | | | | | | | | |

As seen in Tables 2 and 3, lower hysteresis values are obtained in mixtures which are extended by synthetic oils. These samples were tested at 40 Hz and 1% strain. A reduction in tan 8 at 20° C. of about 35-40% is demonstrated.

### Examples 16-19

Samples of four different grades of poly-1-alkenes from Chevron were tested. The compounding formula used was 30% SEPS, 10% PPO/PS, and 60% oil The compounds were mixed in a 50 g Brabender mixer at 250° C. for 30 minutes. The test samples were molded at 200° C. The physical characteristics of these compounds can be seen in Table 3.

TABLE 3

| | 16 | 17 | 18 | 19 |
|---|---|---|---|---|
| Oil | PAO-9 | PAO-7 | PAO-8 | PAO-6 |
| Shore A | 9 | 9 | 9 | 9 |
| 100° C. C.S. | 26% | 32% | 23% | 16% |
| tan δ @ 20° C. | 0.044 | 0.038 | 0.045 | 0.035 |

### Examples 20-25

Polymeric compounds extended with poly-1-decene (PAO-8) were formed in a Brabender mixer by combining varying amounts of poly-1-decene, PPO/PS, SEPS, and, optionally, a small amount of polypropylene. The addition of a small amount of polypropylene raises the hysteresis and Shore A but improved surface smoothness of molded samples. Increasing the PPO level resulted in increasing hysteresis but improved 100° C. compression set. Physical characteristics of these examples can be seen in Table 4, which shows the effects of varying the PPO content and adding polypropylene in the compositions.

TABLE 4

| | 20 | 21 | 22 | 23 | 24 | 25 |
|---|---|---|---|---|---|---|
| SEPS (pbw) | 30 | 25 | 18 | 35 | 25 | 28 |
| PPO/PS (pbw) | 10 | 8.4 | 6 | 5 | 15 | 8 |
| Polypropylene | 0 | 0 | 0 | 0 | 0 | 4 |
| (pbw) | | | | | | |
| PAO-8 | 60 | 66.6 | 76 | 60 | 60 | 60 |
| Shore A | 9 | 3 | 0 | 8 | 10 | 12 |
| 100° C.C.S. | 23% | 29% | 18% | 31% | 17% | 33% |
| tan δ @ 20° C. | 0.045 | 0.041 | Too soft | 0.039 | 0.047 | 0.067 |

We claim:

1. A composition comprising:
a. a polymer comprising at least 2 different blocks each of said blocks being selected from a vinyl-substituted aromatic hydrocarbon and a conjugated diene,
b. at least one polymer comprising a polymeric ether resin, and
c. a synthetic oil comprised of at least one of a polyalkylene.

2. The composition of claim 1 wherein said vinyl-substituted aromatic hydrocarbon is chosen from any one or combination of styrene, α-methylstyrene, p-methyl-styrene, 1-vinylnaphthalene, 2-vinyl-naphthalene, 1α-methylvinylnaphthalene, 2-α-methylvinylnaphthalene, as well as alkyl, cycloalkyl, aryl, alkaryl, and aralkyl derivatives thereof, in which the total number of carbon atoms in the combined hydrocarbon is generally not greater than 18, as well as a di- or tri-vinyl aromatic hydrocarbon.

3. The composition of claim 1 wherein said conjugated diene is one or more of 1,3-butadiene, isoprene, 2,3-dimethyl-1,3-butadiene and 1,3-pentadiene.

4. The composition of claim 1 wherein said ether resin is one or more of any polyphenylene ether, including poly(2,6-dimethyl-1,4-phenylene ether), poly(2-methyl-6-ethyl-1,4-phenylene ether), poly(2,6-diphenyl-1,4-phenylene ether), poly(2-methyl-6-phenyl-1,4-phenylene ether), poly(2,6-dichloro-1,4-phenylene ether), and mixtures thereof.

5. The composition of claim 1 wherein said conjugated diene is hydrogenated after polymerization.

6. The composition of claim 1 wherein said polymeric ether resin comprises a blend with a vinyl-substituted aromatic hydrocarbon polymer.

7. The composition of claim 1 wherein said polyalkylene is one or more of polypropylene, polybutene, polypentene, polyhexene, polyheptene, polyoctene, polynonene, polydecene, polyundecene, polydodecene, and mixtures thereof.

8. The composition of claim 1 wherein said polyalkylene is poly-l-decene.

9. The composition of claim 1 wherein said polyalkylene is poly-1-dodecene.

10. A composition comprising:
a. a polymer with a M_{w} between about 100,000 to 1,000,000, and having at least 3 blocks, at least two blocks consisting of styrene, α-methylstyrene, p-methylstyrene, and mixtures thereof, and at least one block consisting of isoprene, butadiene, and mixtures thereof wherein said isoprene and butadiene are hydrogenated after polymerization;
b. a poly phenylene ether resin with a M_{w} between about 20,000 and 100,000;
c. a synthetic oil consisting of poly-1-decene or poly-1-dodecene, and mixtures thereof, with a Mₙ of between about 500 and 3000; and said composition having a compression set at 100° C. of less than about 50% and a hysteresis value at greater than 10° C. of less than about 0.07.

11. A process for forming a polymer composition comprising mixing
a. a polymer having at least 2 different blocks selected from a vinyl-substituted aromatic hydrocarbon and a conjugated diene,
b. at least one polymer comprising a polymeric ether resin, and
c. a synthetic oil comprised of at least one polyalkylene, so as to provide said composition

12. The process of claim 11 wherein said vinyl-substituted aromatic hydrocarbon is one or more of styrene, α-methylstyrene, p-methylstyrene, 1-vinylnaphthalene, 2-vinyl-naphthalene, 1-α-methylvinylnaphthalene, 2-a-methylvinyl-naphthalene, as well as alkyl, cycloalkyl, aryl, alkaryl, and aralkyl derivatives thereof, in which the total number of carbon atoms in the combined hydrocarbon is generally not greater than 18, as well as a di- or tri-vinyl aromatic hydrocarbon.

13. The process of claim 11 wherein said conjugated diene is one or more of 1,3butadiene, isoprene, 2,3-dimethyl-1,3-butadiene and 1,3-pentadiene.

14. The process of claim 13 wherein said conjugated diene is isoprene.

15. The process of claim 11 wherein said ether resin is one or more of any poly-phenylene ether, including poly(2,6-dimethyl-1,4-phenylene ether), poly(2-methyl-6-ethyl-1,4-phenylene ether), poly(2,6-diphenyl-1,4-phenylene ether), poly(2-methyl-6-phenyl-1,4-phenylene ether), poly(2,6-dichloro-1,4-phenylene ether), and mixtures thereof.

16. The process of claim 15 wherein said ether resin is poly(2,6-dimethyl-1,4-phenylene) oxide.

17. The process of claim 11 wherein said polymeric ether resin comprises a blend with a vinyl-substituted aromatic hydrocarbon polymer.

18. The process of claim 11 wherein said polyalkylene is one or more of polypropylene, polybutene, polypentene, polyhexene, polyheptene, polyoctene, polynonene, polydecene, polyundecene, polydodecene, and mixtures thereof.

19. The process of claim 18 wherein said polyalkylene is poly-l-decene.

20. The process of claim 18 wherein said polyalkylene is poly-1-dodecene.
